(19) United States
(12) Patent Application Publication
(10) Pub. No.: US 2007/0078701 A1
(43) Pub. Date: Apr. 5, 2007

(54) Systems and methods for managing internal controls with import interface for external test results

(76) Inventor: Karol Bliznak, Walldorf (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/239,140

(22) Filed: Sep. 30, 2005

(51) Int. Cl. G06F 11/34

(52) U.S. Cl. 705/11

(57) ABSTRACT

Computer-implemented methods, systems, and computer program products are provided for the management of internal controls. Embodiments consistent with the invention also relate to internal control systems and methods that provide an interface for uploading or importing test results from one application (e.g., an external application for testing controls) to another application (e.g., an internal control documentation application). In one implementation, a computer-implemented method is provided for testing operating effectiveness of controls for a company. The method may comprise creating a test plan, the test plan identifying controls to be tested using an external application and scheduling at least one test with the external application. The method may further comprise electronically uploading control testing results for the scheduled at least one test, the testing results being uploaded from the external application to a control documentation application via an interface and a time window associated with the at least one test.

### BACKGROUND OF THE INVENTION

I. Field of the Invention

The present invention generally relates to data processing systems and related methods and computer program products. More particularly, the invention relates to computer-implemented systems and methods for managing internal controls, including systems and methods that provide an interface for importing external test results.

II. Background Information

In recent years, efforts have been made to apply stricter requirements in the areas of corporate governance, financial disclosures, and accountability for corporate malfeasance. Governments in the United States and other countries have enacted legislation or regulations that impose more demanding requirements on corporations that are publicly listed and/or traded. Such measures are seen as being necessary to restore faith in financial reporting and maintain an orderly marketplace.

The Sarbanes Oxley Act of 2002 is one example of legislation in the area of corporate governance. Sections 302 and 404 of the Sarbanes Oxley Act are among the most relevant sections to public corporations in the United States. Section 302 includes provisions related to disclosure controls and procedures, such as provisions that require management to have responsibility for effective disclosure controls and procedures over financial reporting, operations and compliance. On the other hand, Section 404 sets forth internal controls and procedures for financial reporting, including provisions that require a company's annual report to contain a report by management on the effectiveness of internal control over financial reporting.

Software and computerized applications have been developed to assist companies manage internal controls and test operating effectiveness. For example, Enterprise Resource Planning (ERP) systems and control documentation applications enable companies to document test efforts for measuring the effectiveness of key control activities in material business processes. These and other solutions often require significant investments in terms of information technology (IT) expenditures and the allocation of human resources. Consulting firms and other professionals have also emerged as “specialists” that provide their services to assist corporations to comply with pertinent regulations, including Section 404 of the Sarbanes Oxley Act.

Such approaches are numerous, but often incompatible with one another. For example, many applications in the area of internal controls do not provide an open environment or interface to communicate with or accept data from other software applications. As a result, data from one application (such as an external application, including a third-party or custom made application) may need to be manually inputted or otherwise handled before being processed by another application (such as an internal control documentation application used by an organization). Furthermore, consultants and other specialists usually advocate the use of specific software applications and are not apt to apply or work with software from more than one vendor.

To further illustrate, a tester assigned to test the operating effectiveness of a particular control activity may have to manually perform a predetermined testing procedure. In addition, the tester is typically required to manually document the results of the test with an internal control documentation application. Examples of control documentation applications include the SAP Management of Internal of Controls (MIC) application included with mySAP ERP, available from SAP AG, Walldorf, Germany. For IT-supported control activities, the testing procedure may prescribe logging on to a specialized, external application that provides the required test results. As a result, the tester will be required to go back to the internal control documentation application and document the test results manually in the form of a test log (e.g., Exceptions Found: Yes or No) and an issue (e.g., in the case of exceptions found). This process is highly inefficient as it may require a significant amount of human resources to test even IT-supported controls all across the organization.

In view of the foregoing, there is an underlying problem in current approaches in terms of the inefficient usage of IT investments and human resources. This is evident in more than one area, including the testing of internal controls or control operating effectiveness. This results in costly efforts for a corporation to prove, for example, the effectiveness of key control activities in material business processes and to document the results in a dedicated internal control application.

### SUMMARY OF THE INVENTION

Embodiments consistent with the present invention provide systems and methods for managing internal controls for a company, an organization, or other end user. Embodiments of the invention may be implemented for internal control projects and, in particular, the control operating effectiveness testing phase of an internal control project (e.g., a Sarbanes-Oxley Section 404 compliance project, a project to comply with similar local requirements, or a control project implemented as a best practice).

Embodiments consistent with the invention also relate to internal control systems and methods that provide an interface for importing test results from one application (e.g., an external application) to another application (e.g., an internal application). The external application may be a third party application or a custom made application for testing controls. The internal application may be a control documentation application or similar application that is part of, for example, an ERP system.

Systems and methods consistent with the invention may be computer and/or software implemented and provide a more efficient approach to internal control testing and documentation. In accordance with one embodiment, a computer-implemented method is provided for testing operating effectiveness of controls for a company. The method may comprise creating a test plan, the test plan identifying controls to be tested using an external application and scheduling at least one test with the external application. The method may further comprise electronically uploading control testing results for the scheduled at least one test, the testing results being uploaded from the external application to a control documentation application via a predetermined interface and using a time window related to the scheduling for the at least one test.

As disclosed herein, the interface and uploading of test results may be implemented in accordance with a push principle or approach. For example, with a push approach, the control documentation application may open the time window within which the test results from the external application can be posted. The posted test results may be associated with a specific organizational unit or business group of the company. The time window may be defined by a start date included in the scheduling of the at least one test and an end date when a data freeze functionality applies. In such a case, if the external application attempts to push results for a given control on a current date that is outside the allowed time interval defined by the respective start date and the freeze date, then an error code may be generated and no data will be imported.

In accordance with another aspect, the interface may be adapted to allow the automated creation of a pre-filled test log and an issue protocol in case of reported exceptions. To this end, the interface may include one or more fields, such as an Exceptions field (Yes or No) and a Issue Priority field (High, Medium, or Low). Other fields (e.g., Created By, Test Date, etc.) may also be provided with the interface, as well as text (e.g., Test Log/Issue Title, Comments, Descriptions, etc.) and/or additional information (e.g., links, external documents, etc.). One or more of these items may be stored with the test-log issue in a database.

In one embodiment, the interface is created using XML or another suitable programmable interface. Additionally, or alternatively, the interface may be created based on SAP's Exchange Infrastructure (XI) or as part of an Enterprise Services Architecture (ESA) Xi-interface with data-mapping functionality. Enterprise Services Architecture is the blueprint of a service-oriented architecture for SAP customers. Based on open standards, it allows the seamless integration of SAP, legacy and third party software into composite applications that can enhance and innovate key business processes. An example of technical software that enables ESA includes SAP's Exchange Infrastructure (XI) provided as part of SAP NetWeaver, commercially available from SAP AG, Walldorf, Germany.

Consistent with another aspect, the transfer of external testing results can be performed either automatically or semi-automatically. In the automatic mode, the results may be posted without any human intervention. In the semi-automatic mode, the test results may be imported as a draft and confirmation of the results by a human tester may be necessary.

In accordance with another embodiment, a computer-implemented system is provided for testing operating effectiveness of controls for a company. The system may comprise means for creating a test plan, the test plan identifying controls to be tested using an external application and scheduling at least one test with the external application. The system may further comprise means for electronically uploading control testing results for the scheduled at least one test, the testing results being uploaded from the external application to a control documentation application via a predetermined interface and using a time window associated with the at least one test.

According to a still further embodiment of the invention, a method is providing for the management of internal controls. The method may comprise creating a test plan that identifies controls to be tested using an external application, electronically posting, during a predetermined time window, test results from the external application to an internal application, validating the test results to identify control effectiveness issues, and resolving control effectiveness issues.

As disclosed herein, the external application may comprise a third party or custom made application for testing one or more identified controls. Further, the internal application may comprise a control documentation application or similar application of an ERP system.

Embodiments of the invention further relate to computer-program products and computer readable media comprising instructions for causing a processor or computer to implement methods and systems consistent with the present invention.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 illustrates a flowchart of an exemplary method for the management of internal controls, consistent with an embodiment of the present invention;

FIG. 2 is a flowchart of an exemplary method for testing operating effectiveness and importing test results with an interface, consistent with an embodiment of the invention;

FIG. 3 is a block diagram of an exemplary system environment for implementing embodiments of the invention;

FIG. 4 is a block diagram of an exemplary interface for importing test results, consistent with an embodiment of the invention; and

FIG. 5 illustrates an example of importing test results, consistent with an embodiment of the invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

Embodiments of the invention relate to computerized systems and methods for managing internal controls. Such systems and methods may be used by an organization, a corporation, a company, or other entity to satisfy local and/or regional requirements for corporate governance and financial reporting, such as that required by the Sarbanes Oxley Act. Embodiments of the invention may also be used for a control project implemented as a best practice.

As further disclosed herein, embodiments of the invention also relate to an interface, and systems and methods related thereto, for importing or posting test results from an external application, such as a third party or custom made application, to an internal control application, such as an internal control documentation application of an ERP system.

The test results may relate to the effectiveness of any control activity. For instance, the test results may be generated in relation to the control operating effectiveness testing phase of an internal control project. The interface may also be implemented to import data for control documentation. Examples of commercially available third party applications include Approval BizRights, Virsa Compliance Calibrator, Securinfo for SAP, and Proxyon Runbook.

In accordance with one embodiment, an interface is provided that allows for the import of test results and/or other data to an internal application. The internal application may be an internal control documentation application (such as the SAP MIC application) or similar application related to an ERP system. Additionally, systems and methods may be provided to automatically generate a pre-filled test log and/or create an issue protocol in case of reported exceptions. With an interface consistent with the principles of the invention, it is also possible to transfer additional information (e.g., comments, links, external documents, etc.) associated with a test/log issue that is to be stored in a control documentation application.

In accordance with another embodiment, the transfer of external testing results can be performed automatically (e.g., the results are posted without any human intervention) or semi-automatically (e.g., the results are transferred as a draft, followed by confirmation by a human user).

Embodiments of the invention can help companies and other entities to better leverage their IT investments for control testing and also lower the total cost of ownership (TCO). In one embodiment, the documentation related to test results is automatically included in the control documentation application and, thus, the need to manually type or otherwise input the results into the application is eliminated.

Embodiments of the invention may be implemented for internal control projects and, in particular, the control operating effectiveness testing phase of an internal control project. Such projects may comprise a Sarbanes-Oxley Section 404 compliance project, a project to comply with similar local requirements, or a control project implemented as a best practice.

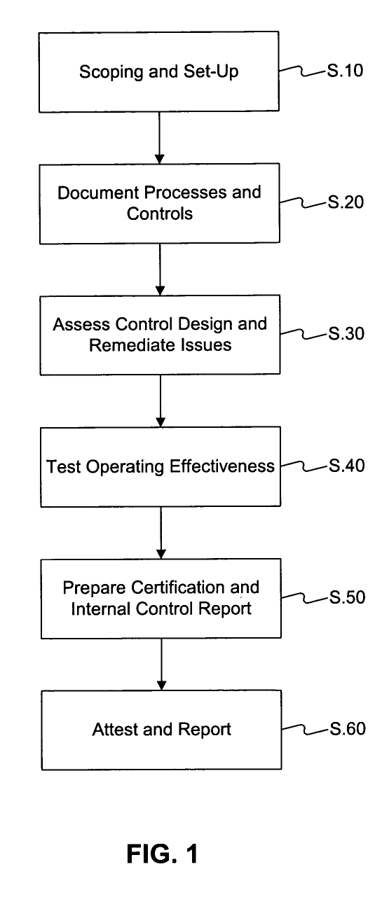

To provide a better understanding of the principles and scope of the invention, a flow chart of an exemplary method for the management of internal controls is provided in FIG. 1. As shown in the embodiment of FIG. 1, the method comprises scoping and project set-up (S.10), documentation of processes and internal controls (S.20), assessment and remediation of issues (S.30), testing of operating effectiveness (S.40), certification and generation of internal control project (S.50), and/or attesting and reporting (S.60). Depending on the internal control project to be implemented, one or more of the steps shown in FIG. 1 can be combined, modified, rearranged, substituted or eliminated. Other modifications can also be made, as will be appreciated by one skilled in the art, including the use of conventional techniques or approaches.

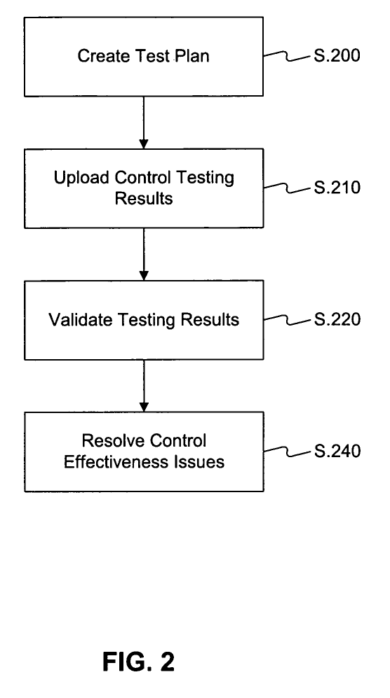

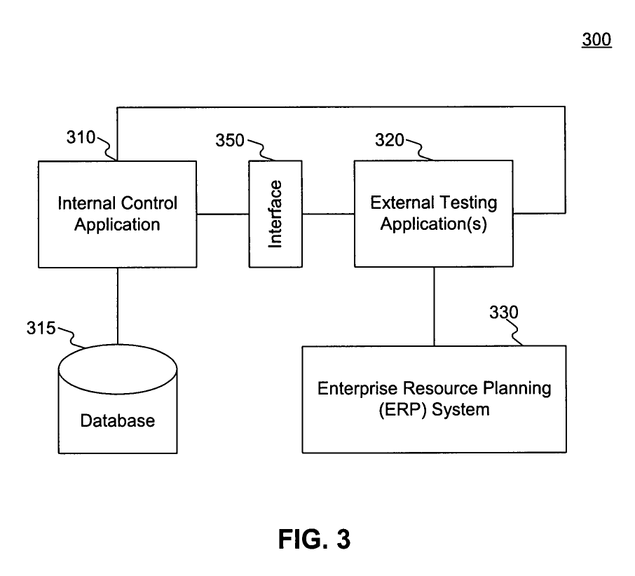

As further disclosed herein, an exemplary process consistent with the invention for testing operating effectiveness (S.40) is described below with reference to FIG. 2. The exemplary process of FIG. 2 includes the uploading or posting of control test results (see S.210) from an external application. Advantageously, the embodiment of FIG. 2 may utilize an interface for facilitating the transfer of test results from one application to another application. The interface may be designed as an “open” interface to facilitate the uploading of test results from one or more different external applications to an internal application of a company or organization. Exemplary embodiments of an interface and associated computer-based environments is provided below with reference to, for example, FIGS. 3, 4 and 5.

Referring again to FIG. 1, scoping and set-up (S.10) may comprise analyzing and identifying organizational units and processes that are to be within the scope of the project. Conventionally, this may include defining management requirements and project structure. Additionally, a hierarchy may be created to indicate the relationship between various organizational units or business units (e.g., Corporate, Legal Entity E1-En, Business Unit BU1-BUn, Shared Services, etc.). There may be unlimited levels within the hierarchy. Furthermore, the organizational unit hierarchy may be generated and stored based on an existing human resources (HR) organizational chart or similar type of chart stored in a database or business warehouse.

Documentation of processes and controls (S.20) may include documenting and describing processes, control objectives, risks, and internal controls. For example, processes that are determined to have a material impact on financial reporting and/or disclosure controls and procedures may be grouped and associated to generate a process hierarchy. The process hierarchy may be business unit-independent and provide a central process catalog. Furthermore, control objectives and risks may be defined in the central catalog. The control objectives and risks may be determined by individuals within the different corporate or business units of the organization as part of S.10 or S.20.

In general, a control objective is a statement that captures the purpose of control(s) within the process. One or more control objectives may be defined for each process. Further, following the COSO framework (i.e., the framework of the Committee of Sponsoring Organization), each control objective may be categorized as Financial, Operational or Compliance related. In contrast, a risk is a potential event that can adversely impact the desired outcome of the control objectives.

As part of S.20, each of the identified processes may be assigned to an organizational unit or business unit. As part of this process, responsible personnel within each business unit may choose from the central process catalog those processes that are applicable and in scope to their business unit. When assigning a process to a business unit, any related process groups may be automatically inherited from the central process catalog.

Consistent with embodiments of the invention, there may be various types of controls. For example, automated controls may exist that are essentially checks or restrictions automatically imposed by a system, such as an ERP system. These controls may depend on the configuration of the system and may comprise controls related to user access, tolerance limits, field validation checks and other key controls. Another type of controls is manual controls. This type of control may be processed-based and reply upon an individual to perform a certain task or to undertake a specific responsibility. Personnel or other individuals may be tasked to perform such actions depending on the required controls.

The assessment and remediation of issues (S.30) may include control design assessment, and the identification and remediation of issues. Using workflows, key managers and other personnel at a company my be tasked with assessing specific controls. To facilitate control design assessment, detailed user interfaces may be provided that include, for example, text entry fields and drop-down selection items. When implemented as one or more graphical user interfaces (GUIs), a user can perform the assessment from his/her computer and report their findings to a central application or database. To the extent issues or exceptions are identified in the control design, management at the company may then assess the same and remediate, as needed. Remediation in stage S.30 may include adding, modifying or otherwise correcting existing controls, as well as reassigning or tasking new individuals to handle, for example, defined manual controls.

As indicated above, the testing of operating effectiveness (S.40) may be carried out consistent with, for example, the embodiment of FIG. 2. In general, testing may encompass testing controls and documenting the test results. Based on the results, any issues or exceptions may be identified and remediated. Advantageously, the testing may be performed with one or more external applications, such as a third party or custom made application, and the test results automatically or semi-automatically uploaded or posted to an internal control documentation application. As further disclosed below, the uploading may be achieved using an interface consistent with the principles of the invention.

Upon completion of testing (S.40), certification and generation of an internal control report (S.50) may be performed, as well as attesting and sign-off (S.60). Stage S.50 may include generating one or more internal control reports that include information on the test results and/or determined operating effectiveness. Before a CEO or CFO can submit a “clean” report to the pertinent authorities, attesting and sign-off (S.60) may be carried out, consistent with conventional approaches. For example, attesting and sign-off may be organized through workflows, with the pertinent personnel using one or more GUIs to submit their ratings, comments, etc. with respect to specific business units, together with their sign-off date.

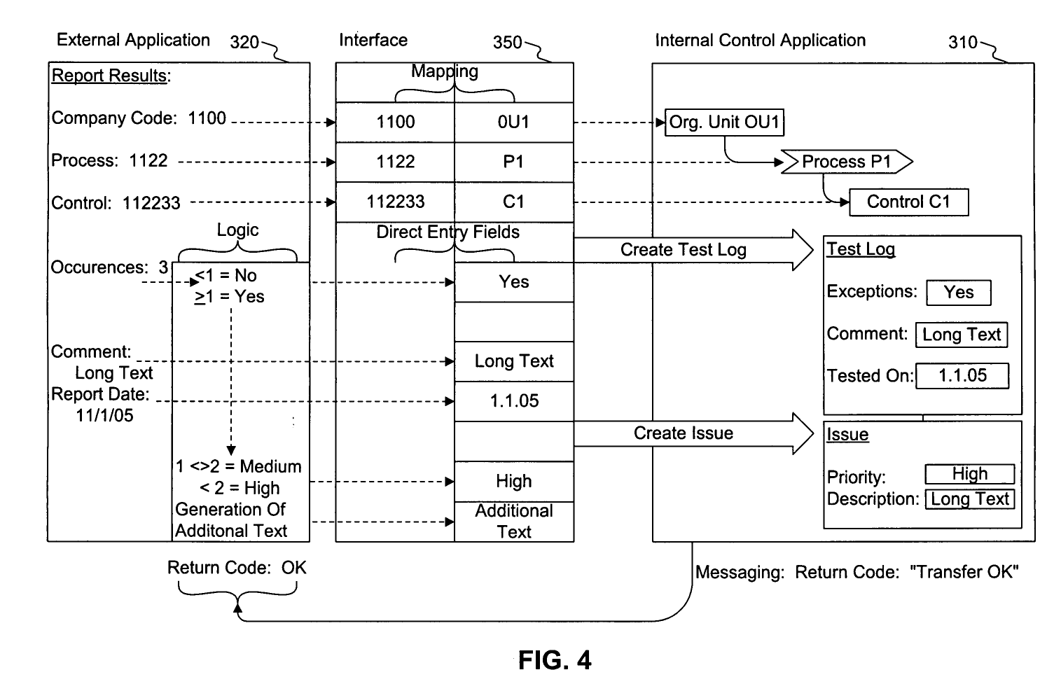

As described above, the testing of operating effectiveness (stage S.40) may be performed using one or more external applications. By way of example, FIG. 2 is a flowchart of an exemplary method for testing operating effectiveness using an interface to facilitate test results from external applications. The embodiment of FIG. 2 may be implemented using a computer-implemented system or environment, such as that illustrated in FIGS. 3 and 4.

Referring to FIG. 2, an exemplary method is shown that includes creating a test plan (S.200), uploading control testing results (S.210), validating testing results (S.220), and resolving control effectiveness issues (S.240). Depending on the test plan and controls to be tested, one or more of the steps in FIG. 2 can be combined, modified, rearranged, substituted or eliminated. Other modifications can also be made, as will be appreciated by those skilled in the art, consistent with the present invention and this disclosure.

For purposes of illustration, the embodiment of FIG. 2 will be described with reference to an internal control documentation application that is responsible for documenting the results of testing activities. Further, reference will be made to at least one external application that is responsible for performing tests and providing test results to the internal control documentation application. While reference is made to these specific applications, it will be appreciated by those skilled in the art that the principles of FIG. 2 and that of the claimed invention may be applied to different environments and application arrangements. For example, testing may be performed by using a plurality of external applications. Additionally, or alternatively, one or more the tests may be performed by the internal control documentation application or related internal system software (e.g., another application within an ERP system).

Creating a test plan (S.200) may include specifying what controls are to be tested and how they should be tested. A test plan containing this information may be created by, for example, manager(s) or other designated personnel for each business unit. The test plan may also include scheduling information that indicates when each test is to be performed and assignment information regarding testers. In addition, controls may be certified for automated or self-automated testing via a specific external application. For this purpose, a certification attribute may be provided that indicates what type of testing is permitted. In one embodiment, a basic assumption may be that a control cannot be automatically tested unless automatic testing is explicitly allowed for the control by an authorized person. In such a case, an internal auditor may set the certification attribute to indicate whether automated testing or self-automated testing is permitted. In the automated mode, the results may be posted to the internal application without any human intervention. In contrast, in the semi-automated mode, the test results may be uploaded or imported only as a draft, with confirmation of the results by a human tester being necessary.

The certification attribute may be linked with the respective control. In one embodiment, the certification attribute information may enhance a set of testing attributes at the control level by the following field:

| Field | Possible Values |
|---|---|
| Test Automation Allowed | Automated testing |
| | Semi-automated testing |
| | Manual/Not allowed |

In the above embodiment, the attribute may be set to “Manual/Not allowed” as a default for any newly created control.

Referring again to FIG. 2, uploading control testing results (S.210) may be performed with respect to the testing results from one or more external applications. As a prerequisite, each control may be required to have a testing attribute that indicates whether automated or self-automated testing is permitted from an external application. In such a case, uploading or importing of the test results may be achieved through an interface (see, e.g., FIGS. 3 and 4). Consistent with embodiments of the invention, the testing results may include automatically generated test logs and/or potential issues. For example, the interface may include one or more fields, such as an Exceptions field (Yes or No) and an Issue Priority field (High, Medium, or Low). Other fields (e.g., Created By, Test Date, etc.) can be provided with the interface, as well as text (e.g., Test Log/Issue Title, Comments, Descriptions, etc.) and/or additional information (e.g., links, external documents, etc.). Further details regarding interfaces consistent with the present invention are provided below.

In one embodiment, the interface and uploading of test results may be implemented in accordance with a “push” principle. As referred to herein, “push” means that the test results may not have been explicitly requested by an application. Instead, an upload interface may be open during various times for possible uploads from external applications. For example, with a push approach, the internal control documentation application may open the time window within which test results from an external application can be posted. The posted test results may be associated with a specific organizational unit or business group of the company. The applicable time window may be defined by a start date included in the scheduling of the at least one test and an end date when a data freeze functionality applies. A user of the internal control documentation application (such as a business-type person with knowledge of required due dates of compliance-ensuring filings) may outline the milestones within a compliance project to ensure due dates are met. Such a user may schedule a test by entering start and end dates into the application. In one embodiment, this information is stored as part of the test plan. The time window is opened automatically by the internal control documentation application as defined by the start and end dates set by the user. With the push approach, if the external application attempts to push results for a given control on a current date that is outside the allowed time interval defined by the respective start date and the freeze date, then an error code may be generated and sent to the external application. In this case, no data will be imported to the internal application.

As an alternative to a push approach, it is also possible for a pull implementation to be utilized for uploading test results. With a pull approach, the internal application may poll or request the test results from the applicable external application consistent with a defined time window or on a predetermined schedule. If test results are available, then the results are requested and imported into the control documentation application via the interface.

In accordance with another aspect, the interface may be adapted to allow the automated creation of a pre-filled test log and an issue protocol in case of reported exceptions. Test log and issue fields may include an Exceptions field (Yes or No) and an Issue Priority field (High, Medium, or Low). Additional texts (test log/issue title, comments, descriptions) and other fields (created by, test date) can also be influenced by the interface.

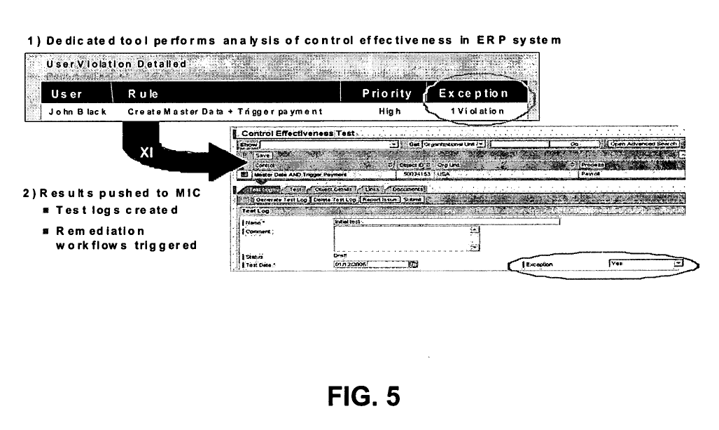

By way of example, FIG. 5 illustrates an exemplary embodiment of importing test results, consistent with the present invention. The example of FIG. 5 relates to an automated testing scenario where test results are pushed to an internal control documentation application. In particular, to upload control test results, a dedicated tool or third party application may first perform an analysis of control effectiveness within an environment, such as an ERP system. The test results may indicate various violations, such as the violation of a rule (e.g., “Create Master Data and Trigger Payment”) to be performed by a designated user (e.g., “John Black”). The priority (e.g., “High”) and exception value (e.g., “1 Violation”) may be recorded as well. Using a push method, as described above, the test results may be imported via an interface (see, e.g., the “XI” interface of FIGS. 3 and 4) to a control documentation application (e.g., MIC), consistent with the principles of the invention. In response to the upload, test logs may be created and/or remediation workflows may be triggered, as further disclosed herein.

Referring again to FIG. 2, subsequent to uploading (S.210), the test results may be validated (S.220). Validation may be implemented using one or more processes. In accordance with one embodiment, when automated testing data is imported, further activities are triggered based on the test automation type that is selected (e.g., semi-automated test or automated test).

For a “semi-automated test,” a test log and a possible issue can be posted under the status “draft.” In such a case, a workflow notification may be sent to a human tester assigned to the semi-automatic testing slot. The task text may comprise, for example, appropriate text such as “Validate semi-automatic test”. The human tester can then log onto the system and work as if he/she created the test log and the possible issue (i.e., the fields can be modified by the tester). Finally, the tester may submit the test log with the possible issue.

With an “automated test” type, the test log and a possible issue can be imported directly under the status “submitted.” Hence, an issue processor filed may be pre-filed automatically by the name of the person assigned as the default issue owner for the given business unit. Furthermore, the issue may be sent via the workflow to a processor.

After validating the testing results (S.220), control effectiveness issues may be resolved (S.240). Various processes may be implemented for handling resolution. In one embodiment, the issue resolution procedure occurs outside of the system and is documented in the control documentation application. If a particular issues requires a more complex solution, a remediation measure may be documented in the control documentation application in the form of a remediation plan. The status of the remediation plan can be regularly updated by a person assigned as a remediation plan owner. After the issue is resolved, new test results may be uploaded from the external application to the control documentation application.

As disclosed herein, an interface may be provided to facilitate the uploading or pushing of information to an internal control documentation application. Various technologies may be utilized for implementing the interface. For example, the interface may be XML-based or any other software-based solution that is adapted to be executed on a computer or processor. By way of example, FIG. 3 illustrates an exemplary system environment 300 for providing such an interface 350, consistent with the present invention. The interface of FIG. 3 may be implemented using various technologies. By way of example, the interface may be created based on SAP's Exchange Infrastructure (XI) or as part of an Enterprise Services Architecture (ESA) XI-interface with data-mapping functionality. Enterprise Services Architecture is the blueprint of a service-oriented architecture for SAP customers. Based on open standards, it allows the seamless integration of SAP, legacy and third party software into composite applications that can enhance and innovate key business processes. An example of technical software that enables ESA includes SAP's Exchange Infrastructure (XI) provided as part of SAP NetWeaver, commercially available from SAP AG, Walldorf, Germany. The interface of FIG. 3, may also be implemented using other suitable configurations, such as an XML or other programmable interface.

In particular, as shown in FIG. 3, system environment 300 includes a number of components, including an internal control application 310, a database 315, an ERP system or platform 330, one or more external testing application(s) 320, and an interface 350. Internal control application 310 may be implemented as a control documentation application (such as MIC) and receive test results from external testing application(s) 320 via interface 350. Control application 310 and external testing application(s) 320 may also directly communicate with one another via, for example, a system network or internal bus network. In a similar manner, communication with the other components (e.g., database 315, ERP system 330) may be implemented for issuing commands, communicating data, etc. As will be appreciated by one skilled in the art, the various applications and components of system environment 300 may be hosted or executed on any number of computers or other processors and, therefore, FIG. 3 should not be interpreted as limiting the arrangement or configuration of the applications and components of system environment 300.

In accordance with one embodiment, interface 350 may be defined with one or more objects or fields to support the transfer of test results and/or other information between external testing application(s) 320 and internal control application 310. By way of example, the objects or fields may comprise one or more of the following:

| Object | Description |
|---|---|
| Organizational Unit | An Organizational Unit represents a |
| | legal entity, a geography, a functional |
| | area or business unit. These units |
| | may be combined to form an |
| | organizational hierarchy. |
| Process Group | A Process Group is a set of |
| | processes (e.g., Sales). A structure |
| | of process groups can be cascading |
| | and must end with a process. |
| Process | A Process is a set of activities that |
| | are functionally defined and relate |
| | directly or indirectly to Financial |
| | Statement Accounts (e.g., to satisfy |
| | the requirements of SOX Section |
| | 404) and disclosure controls and |
| | procedures (e.g., to satisfy the |
| | requirements of SOX Section 302). |
| Process Step (=Control) | Process step is an activity performed |
| | within a process. Each |
| | Organizational Unit defines process |
| | steps and their sequence for each |
| | process in scope. Thus, process |
| | steps are Organizational Unit and |
| | Process Dependent. Some process |
| | steps represent a Control and are |
| | marked with the flag “Is a control”. A |
| | Control is an activity that is intended |
| | to mitigate the risks of a process not |
| | meeting the associated control |
| | objective. |
| Timeframe | A more granular part of a timeframe |
| | (e.g., August, Q1, Week 32). |
| Timeframe Year | The year of the timeframe (e.g., |
| | 2004, 2005). |
| Created by | The identification of the |
| | person/system who submitted the |
| | given test log. In manual testing, the |
| | system person of the particular tester |
| | is inserted. In automatic testing, it |
| | can be an identification of a third |
| | party system that transferred its |
| | results to the control documentation |
| | application. |
| Test Date | The date on which the test was |
| | actually performed. |
| Test Log Name | A title to be submitted with the test |
| | log (e.g., Initial Test). |
| Testing Method | Indicating whether the test followed |
| | the standard procedure prescribed |
| | for the given control. There may be |
| | two options: standard testing method, |
| | and custom testing method. If set to |
| | custom, testing technique and |
| | Testing Procedure must be entered |
| | (see below). |
| Testing Procedure | The field provides detailed |
| | information on how the particular |
| | control tested. |
| Testing Technique | Indicating the means for testing, |
| | ranging from simple inquiry |
| | (interviews) to formal re-performance |
| | of the control within the process. |
| Exceptions | This field indicates whether there was |
| | a negative outcome from the testing |
| | procedures. |
| Comment | A text field for free text as additional |
| | information on the test log. |
| Issue Title | The title of an Issue as a shortcoming |
| | related to a control, management |
| | control or a process. |
| Issue Priority | Priority of the issue (e.g. high, |
| | medium, low). |
| Description | The long-text description of an Issue |
| | as a shortcoming related to a control, |
| | management control or a process; |
| | explanation of the cause of the issue. |
| Implication | A long-text explanation of the |
| | potential impact of the issue on the |
| | process/the business. |
| Compensating Controls | The long-text description if there are |
| | any controls in place that would |
| | compensate for the control |
| | associated with the issue. |
| Issue reported by | The identification of the |
| | person/system who submitted the |
| | given issue. In automatic testing, it |
| | can be an identification of a third |
| | party system that transferred its |
| | results to MIC (identical with Created |
| | by - from the test log attributes). |
| Notification text | Sometimes instead of creating a test |
| | log, a notification with text |
| | information can be sent from a third |
| | party application to the control |
| | documentation application to |
| | facilitate semi-automated tests. |
| Notification link | A text string or URL link to the |
| | external application if necessary for |
| | further analysis. |

In one embodiment, the most significant fields include “Control,” “Exception” and “Issue Title.” “Control” must be filled to ensure the testing results uploaded are assigned to the respective control. The “Exception” flag is critical to indicate the substance of a testing result and whether the control is effective (no exceptions) or deficient (exceptions found).

In addition to the fields identified above, other attributes (e.g., Created on Date, Tester, Issue Type, etc.) may be filled automatically by the internal control documentation application 310. In one embodiment, automatic fill-in is achieved because the internal control documentation application 310 already contains the information on which date the results were uploaded (i.e., the current system data) or on other attributes (e.g., Issue Type is always “effectiveness” issues when uploading effectiveness test results, etc). Thus, certain fields do not have to be explicitly provided by an external testing application.

In operation, external testing application(s) 320 may be executed to investigate control effectiveness, such as the effectiveness of prescribed authorizations or control execution logs. Reports are then pushed by external testing application(s) 320 to interface 350. The external application may use a communication protocol of a web-based service for exchanging information. By way of example, a lightweight protocol, such as the Simple Object Access Protocol (SOAP) protocol or another XML-based protocol, may be used for the communication protocol. In turn, interface 350 posts the test results as test logs to internal control application 310. The interface 350 may write the results to the internal control application 310 by updating the database tables of database 315 directly. The test logs and information posted at internal control application 310 are then made available to database 315, which may serve as a business warehouse or central repository for the company or organization. Optionally, direct access to reports made persistent by external testing application(s) 320 may be provided via, for example, URL links. In such a case, detailed views on the testing results are available from the internal control application 310.

To further illustrate the features and functionality of interface 350, FIG. 4 provides a more detailed example of importing test results from external testing application(s) 320. As shown in FIG. 4, external application 320 has report results for uploading to internal control application 310. The report results may include various information, such as the Company Code, Process and Control for which the test results pertain to, as well as specific information such as the number of Occurrences and long or extra Text. Upon posting to interface 350, the information from external application 320 may be mapped and/or otherwise processed by the interface for suitable uploading to internal control application 310. The mapping or processing may be handle in accordance with the predetermined objects or fields for handling data, such as those identified in the above table. The mapping table may be defined by a user in the external testing application(s) 320. Based on this information in the mapping table, the uploaded data is attributed directly to a correct object in the internal control documentation application 310. Mapping or processing by interface 350 may include mapping a Company Code used in external application 310 (such as “1100”) to one suitable for use in internal control application 310 (such as “OU1”). Further, certain data from external application 320 may be identified and processed for direct entry into one or more fields, as represented in FIG. 4.

In accordance with one embodiment, the posted data from external application 320 may be used to automatically create a test log and an issue in internal control documentation application 310. The test log may include various information, such as Exceptions (Yes or No), Comment (long text) and Tested On (date). Further, the created issue may include information such as the Priority status (High, Medium, Low, etc.) and a Description regarding the same (long text). The test log may be automatically consolidated together based on the information provided by the external application 320 via the interface 350. The fields of the interface 350 may correspond with the individual fields of the test log that are normally available for a manual entry. In the case of an upload of results, the individual fields at the test log and issue levels may be filled automatically.

After the uploading of test results, the external application 320 will receive a return code from control documentation application 310 to confirm whether the import was successful. Possible return codes include the following:

| Return Code | Text | Explanation |
|---|---|---|
| O.K. | Import successful | Results posted without |
| | | problems. |
| Error 1 | No automated test | No automated test is |
| | assigned in the given | planned for the given |
| | timeframe. | control. |
| Error 2 | Date not within | The external application |
| | scheduled time interval | tried to send testing data |
| | for testing. | outside the time interval |
| | | for testing for the given |
| | | organizational unit in the |
| | | organizational unit |
| | | specific scheduling |
| | | transaction (e.g., defined |
| | | by the start- and end- |
| | | dates). |
| Error 3 | A test log with non- | Similar to manual tests, |
| | resolved issues already | it is not possible to |
| | exists. | create a new test log for |
| | | the given tester's slot |
| | | when issues are active |
| | | (in any status different to |
| | | “resolved” or |
| | | “completed”). |
| Error 4 | No issue created for a | If the external |
| | test log with exceptions. | application tries to |
| | | import a test log with |
| | | Exceptions=Yes, but an |
| | | issue is not proposed in |
| | | the imported record. |
| — | Other errors (wrong | |
| | record structure etc.). | |

Return codes may be transmitted using a web-based service via a communication protocol for exchanging information, such as an Extensible Markup Language (XML) based protocol. In one embodiment, a lightweight protocol is used to communicate the return codes, such as the Simple Object Access Protocol (SOAP) protocol.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A computer-implemented method for testing operating effectiveness of controls for a company, the method comprising:
creating a test plan, the test plan identifying controls to be tested using at least one external application;
scheduling at least one test with the external application; and
electronically uploading control testing results for the scheduled at least one test, the testing results being uploaded from the external application to a control documentation application using an interface and a time window related to the scheduling for the at least one test.

2. The computer-implemented method of claim 1, wherein the uploading of test results is implemented in accordance with a push procedure.

3. The computer-implemented method of claim 1, wherein electronically uploading comprises:
defining the time window based on a start date included in the scheduling of the at least one test and an end date when a data freeze functionality applies.

4. The computer-implemented method of claim 3, wherein if there is an attempt to upload control testing results on a date that is outside the time window defined by the respective start date and the freeze date, then an error code is generated and no data is uploaded.

5. The computer-implemented method of claim 1, further comprising automatically creating of a pre-filled test log and an issue for reported exceptions.

6. A system for testing control operating effectiveness, the system comprising:
means for creating a test plan, the test plan identifying controls to be tested using at least one external application;
means for scheduling at least one test with the external application; and
means for electronically uploading control testing results for the scheduled at least one test, the testing results being uploaded from the external application to a control documentation application using an interface and a time window associated with the at least one test.

7. The system of claim 6, wherein the uploading of test results is implemented in accordance with a push procedure.

8. The system of claim 6, wherein the means for electronically uploading comprises means for defining the time window based on a start date included in the scheduling of the at least one test and an end date when a data freeze functionality applies.

9. The system of claim 8, wherein if there is an attempt to upload control testing results on a current date that is outside the time window defined by the respective start date and the freeze date, then an error code is generated and no data is uploaded.

10. The system of claim 6, further comprising means for automatically creating of a pre-filled test log and an issue for reported exceptions.

11. A computer program product with a computer program stored thereon for providing a user-interface, the computer program comprising instructions operable to cause the computer to perform a method comprising:
creating a test plan, the test plan identifying controls to be tested using an external application;
scheduling at least one test with the external application; and
electronically uploading control testing results for the scheduled at least one test, the testing results being uploaded from the external application to a control documentation application using an interface and a time window for the at least one test.

12. The method of claim 11, wherein the uploading of test results is implemented in accordance with a push procedure.

13. The method of claim 11, wherein electronically uploading comprises:
defining the time window based on a start date included in the scheduling of the at least one test and an end date when a data freeze functionality applies.

14. The method according to claim 13, wherein if there is an attempt to upload control testing results on a current date that is outside the time window defined by the respective start date and the freeze date, then an error code is generated and no data is uploaded.

15. A method for the management of internal controls, the method comprising:
providing a test plan that identifies controls to be tested using an external application;
electronically posting, during a predetermined time window, test results from the external application to an internal control documentation application, wherein posting is achieved using an interface and a push procedure;
validating the test results to identify control effectiveness issues; and
resolving control effectiveness issues.
